(19) United States
(12) Patent Application Publication
(10) Pub. No.: US 2025/0175298 A1
(43) Pub. Date: May 29, 2025

(54) WIRELESS COMMUNICATION METHOD, USER EQUIPMENT, AND BASE STATION

(71) Applicant: HUIZHOU TCL MOBILE COMMUNICATION CO., LTD., Huizhou, Guangdong (CN)

(72) Inventor: Aijuan FENG, Huizhou, Guangdong (CN)

(73) Assignee: HUIZHOU TCL MOBILE COMMUNICATION CO., LTD., Huizhou, Guangdong (CN)

(21) Appl. No.: 18/839,437

(22) PCT Filed: Feb. 18, 2022
(86) PCT No.: PCT/CN2022/076968

§ 371 Date: Aug. 18, 2024

(51) Int. Cl. H04L 5/00; H04W 56/00; H04W 72/20

(52) U.S. Cl. CPC H04L 5/005; H04W 56/001; H04W 72/20

(57) ABSTRACT

The disclosure provides a wireless communication method, a base station, and a user equipment (UE) for processing a synchronization signal block (SSB) for an extended device type, including but not limited to a device type of RedCap UE. The base station determines a pattern of the SSB for the extended device type, comprising location information of radio resources allocated to a primary synchronization signal (PSS), a secondary synchronization signal (SSS), and a physical broadcast channel (PBCH) of the SSB, a pattern of demodulation reference signal (DMRS) and periodicity of SSB bursts for the extended device type. The SSB for the extended device type may be transmitted by the base station and received by the UE during a random access procedure.

### TECHNICAL FIELD

The present disclosure relates to the field of communication systems, and more particularly, to wireless communication method, user equipment, and base station.

### BACKGROUND ART

Wireless communication systems, such as the third-generation (3G) of mobile telephone standards and technology are well known. Such 3G standards and technology have been developed by the Third Generation Partnership Project (3GPP). The 3rd generation of wireless communications has generally been developed to support macro-cell mobile phone communications. Communication systems and networks have developed towards being a broadband and mobile system. In cellular wireless communication systems, user equipment (UE) is connected by a wireless link to a radio access network (RAN). The RAN comprises a set of base stations (BSs) that provide wireless links to the UEs located in cells covered by the base station, and an interface to a core network (CN) which provides overall network control. As will be appreciated the RAN and CN each conduct respective functions in relation to the overall network. The 3rd Generation Partnership Project has developed the so-called Long Term Evolution (LTE) system, namely, an Evolved Universal Mobile Telecommunication System Territorial Radio Access Network, (E-UTRAN), for a mobile access network where one or more macro-cells are supported by a base station known as an eNodeB or eNB (evolved NodeB). More recently, LTE is evolving further towards the so-called 5G or NR (new radio) systems where one or more cells are supported by a base station known as a gNB.

### TECHNICAL PROBLEM

In 3GPP Rel-17, a Work Item (WI) “Support of reduced capability NR devices” has been started to develop. The objectives of this WI include supporting the UE complexity reduction features, for example, reducing maximum UE bandwidth and minimum number of Rx branches.

The reduced capability UEs (RedCap UEs) include:
Industrial wireless sensor: The type of RedCap UE comprises pressure sensors, humidity sensors, thermometers, motion sensors, accelerometers, actuators, etc.
Surveillance cameras in the smart city use case: The type of RedCap UE performs data collection and processing to more efficiently monitor and control city resources to provide services to city residents.
Wearable devices: The type of RedCap UE comprises smartwatches, rings, eHealth-related devices, medical monitoring devices, etc.

In 3GPP release seventeen (Rel-17 or R17), the maximum bandwidth supported by Redcap UEs was the initial hot topic of discussion, considering time constraints and prioritization of requirements, in R17 FR1 supports the maximum bandwidth of 20 MHz and FR2 supports the maximum bandwidth of 100 MHz. However, the maximum bandwidth of 5 MHz in FR1 is also supported by many companies, which have a large market for wearable devices, industrial sensors, and other applications. RedCap UE with 5 MHz maximum transmission bandwidth configuration is very beneficial to the reduction of device size, complexity, and cost. Therefore, the maximum bandwidth of 5 MHz is a major topic in R18, which has been approved in RAN#94e meeting.

The maximum transmission bandwidth configuration N_{RB} for each UE channel bandwidth and subcarrier spacing (SCS) is specified in the following table (the same as TS38.101 Table 5.3.2-1).

TABLE 1
Maximum transmission bandwidth configuration N_{RB} (TS38.101 Table 5.3.2-1)

| Frequency | SCS | Resource block (RB) number of single carrier bandwidth (MHz) | | | | | | | | | | | | | |
|---|---|---|---|---|---|---|---|---|---|---|---|---|---|---|---|
| range | (kHz) | 5 | 10 | 15 | 20 | 30 | 40 | 50 | 60 | 70 | 80 | 90 | 100 | 200 | 400 |
| FR1 | 15 | 25 | 52 | 79 | 106 | 160 | 216 | 270 | — | — | — | — | — | — | — |
| | 30 | 11 | 24 | 38 | 51 | 78 | 106 | 133 | 162 | 189 | 217 | 245 | 273 | — | — |
| | 60 | — | 11 | 18 | 24 | 38 | 51 | 65 | 79 | 93 | 107 | 121 | 135 | — | — |
| FR2 | 60 | — | — | — | — | — | — | 66 | — | — | — | — | 132 | 264 | — |
| | 120 | — | — | — | — | — | — | 32 | — | — | — | — | 66 | 132 | 264 |

Each synchronization signal block (SSB) occupies four orthogonal frequency division multiplexing (OFDM) symbols in the time domain and 240 subcarriers (20 RBs) in the frequency domain. The SSB subcarrier interval supports μ∈ {0,1} for FR1, namely 15 kHz and 30 KHz. μ∈ {2,3} for FR2, i.e., 60 kHz, 120 KHz. As shown in the above table, 5 MHz bandwidth cannot support 30 kHz SSB.

### TECHNICAL SOLUTION

An object of the present disclosure is to propose a user equipment (UE), a base station, and a wireless communication method.

In a first aspect, an embodiment of the invention provides a wireless communication method executable in a base station, comprising:
determining a pattern of a separate synchronization signal block (SSB) for an extended device type, wherein radio resources defined by a number of symbols in a time domain and bandwidth in a frequency domain are allocated to the separate SSB for the extended device type; and
transmitting the separate SSB for the extended device type on the radio resources;
wherein the separate SSB for the extended device type comprises a primary synchronization signal (PSS), a secondary synchronization signal (SSS), and a physical broadcast channel (PBCH) for the extended device type;
wherein the PBCH for the extended device type is separated from the PSS for the extended device type and the SSS for the extended device type in the time domain.

In a second aspect, an embodiment of the invention provides a base station comprising a processor configured to call and run a computer program stored in a memory, to cause a device in which the processor is installed to execute the disclosed method.

In a third aspect, an embodiment of the invention provides a wireless communication method executable in a user equipment (UE), comprising:
determining a pattern of a separate synchronization signal block (SSB) for an extended device type, wherein radio resources defined by a number of symbols in a time domain and bandwidth in a frequency domain are allocated to the separate SSB for the extended device type; and
receiving the separate SSB for the extended device type on the radio resources;
wherein the separate SSB for the extended device type comprises a primary synchronization signal (PSS), a secondary synchronization signal (SSS), and a physical broadcast channel (PBCH) for the extended device type;
wherein the PBCH for the extended device type is separated from the PSS for the extended device type and the SSS for the extended device type in the time domain.

In a fourth aspect, an embodiment of the invention provides a user equipment (UE) comprising a processor configured to call and run a computer program stored in a memory, to cause a device in which the processor is installed to execute the disclosed method.

The disclosed method may be implemented in a chip. The chip may include a processor, configured to call and run a computer program stored in a memory, to cause a device in which the chip is installed to execute the disclosed method.

The disclosed method may be programmed as computer executable instructions stored in non-transitory computer readable medium. The non-transitory computer readable medium, when loaded to a computer, directs a processor of the computer to execute the disclosed method.

The non-transitory computer readable medium may comprise at least one from a group consisting of: a hard disk, a CD-ROM, an optical storage device, a magnetic storage device, a Read Only Memory, a Programmable Read Only Memory, an Erasable Programmable Read Only Memory, EPROM, an Electrically Erasable Programmable Read Only Memory and a Flash memory.

The disclosed method may be programmed as a computer program product, which causes a computer to execute the disclosed method.

The disclosed method may be programmed as a computer program, which causes a computer to execute the disclosed method.

### ADVANTAGEOUS EFFECTS

The invention provides an SSB for UEs a small maximum bandwidth (referred to as separate SSB hereafter), such as 5 MHz, that can coexist with SSB in R15/R16/R17 (referred to as legacy SSB hereafter).

### DESCRIPTION OF DRAWINGS

In order to more clearly illustrate the embodiments of the present disclosure or related art, the following figures will be described in the embodiments are briefly introduced. It is obvious that the drawings are merely some embodiments of the present disclosure. A person having ordinary skill in this field can obtain other figures according to these figures without paying the premise.

FIG. 1 illustrates a schematic view showing an example wireless communication system comprising a user equipment (UE), a base station, and a network entity.

FIG. 2 illustrates a schematic view showing an embodiment of the disclosed method.

FIG. 3 illustrates a schematic view showing a time-frequency structure of a synchronization signal block (SSB).

FIG. 4 illustrates a schematic view showing examples of a structure of the separate SSB for the extended device type where four symbols are allocated to physical broadcast channel (PBCH).

FIG. 5 illustrates a schematic view showing examples of a structure of the separate SSB for the extended device type where five symbols are allocated to physical broadcast channel (PBCH).

FIG. 6 illustrates a schematic view showing examples of a structure of the separate SSB for the extended device type where the difference between X_{PBCH} and Xₛₛ is an odd number.

FIG. 7 illustrates a schematic view showing examples of a structure of the separate SSB for the extended device type with frequency alignment.

FIG. 8 illustrates a schematic view showing examples of demodulation reference signal (DMRS) and frequency offset where M=4 and Z=4.

FIG. 9 illustrates a schematic view showing an example of a DMRS pattern of a separate SSB

FIG. 10 illustrates a schematic view showing examples of sparse DMRS density and DMRS-less in certain PBCH symbol(s).

FIG. 11 illustrates a schematic view showing examples of increasing DMRS density in certain PBCH symbol(s).

FIG. 12 illustrates a schematic view showing legacy SSB candidate locations in time domain according to TS 38.213 v16.5.0.

FIG. 13 illustrates a schematic view showing an example of candidate locations in time domain for separate SSB burst in a half frame.

FIG. 14 illustrates a schematic view showing an example of candidate locations in time domain for separate SSB burst(s) in a frame.

FIG. 15 illustrates a schematic view showing examples of the pattern of candidate slots.

FIG. 16 illustrates a schematic view showing examples of the pattern of candidate SSBs.

FIG. 17 illustrates a schematic view showing examples of candidate locations in candidate slots for separate SSB.

FIG. 18 illustrates a schematic view showing examples of candidate locations in candidate slots for separate SSB.

FIG. 19 illustrates a schematic view showing examples of candidate locations in candidate slots for the separate SSBs in one half frame or in consecutive half frames.

FIG. 20 illustrates a schematic view showing examples of candidate locations in candidate slots for the separate SSBs in one half frame.

FIG. 21 illustrates a schematic view showing examples of candidate locations in candidate slots for the separate SSB in consecutive half frames.

FIG. 22 illustrates a schematic view showing examples of the same SSB periodicity.

FIG. 23 illustrates a schematic view showing examples of different SSB periodicities.

FIG. 24 illustrates a schematic view showing a system for wireless communication according to an embodiment of the present disclosure.

### DETAILED DESCRIPTION OF EMBODIMENTS

Embodiments of the disclosure are described in detail with the technical matters, structural features, achieved objects, and effects with reference to the accompanying drawings as follows. Specifically, the terminologies in the embodiments of the present disclosure are merely for describing the purpose of the certain embodiment, but not to limit the disclosure.

The disclosure provides a wireless communication method, a base station, and a user equipment (UE) for processing a synchronization signal block (SSB) for an extended device, such as a device type of RedCap UE. The SSB for the extended device type may be transmitted by the base station and received by the UE during a random access procedure. Note that even though the device type of RedCap UE is described as an example of the extended device type in the description, the disclosed method may be applied to any other specific device type or service type in the future. Examples of other specific device types may comprise a device type of machine equipment (ME) for machine type communication (MTC), massive internet of things (lot) devices, Ultra-reliable low-latency communication (URLLC) device, extended reality (XR) device, drones, and mission critical devices.

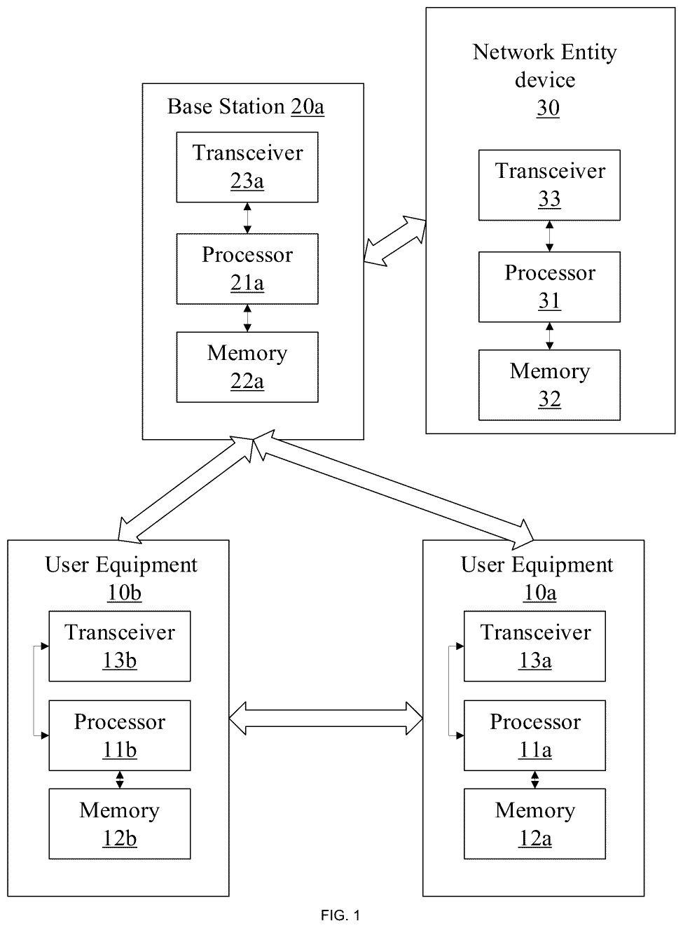

With reference to FIG. 1, a telecommunication system including a UE 10a, a UE 10b, a base station (BS) 20a, and a network entity device 30 executes the disclosed method according to an embodiment of the present disclosure. FIG. 1 is shown for illustrative not limiting, and the system may comprise more UEs, BSs, and CN entities. Connections between devices and device components are shown as lines and arrows in the FIGs. The UE 10a may include a processor 11a, a memory 12a, and a transceiver 13a. The UE 10b may include a processor 11b, a memory 12b, and a transceiver 13b. The base station 20a may include a processor 21a, a memory 22a, and a transceiver 23a. The network entity device 30 may include a processor 31, a memory 32, and a transceiver 33. Each of the processors 11a, 11b, 21a, and 31 may be configured to implement proposed functions, procedures and/or methods described in the description. Layers of radio interface protocol may be implemented in the processors 11a, 11b, 21a, and 31. Each of the memory 12a, 12b, 22a, and 32 operatively stores a variety of programs and information to operate a connected processor. Each of the transceivers 13a, 13b, 23a, and 33 is operatively coupled with a connected processor, transmits and/or receives radio signals or wireline signals. The base station 20a may be an eNB, a gNB, or one of other types of radio nodes, and may configure radio resources for the UE 10a and UE 10b.

Each of the processors 11a, 11b, 21a, and 31 may include an application-specific integrated circuit (ASICs), other chipsets, logic circuits and/or data processing devices. Each of the memory 12a, 12b, 22a, and 32 may include read-only memory (ROM), a random access memory (RAM), a flash memory, a memory card, a storage medium and/or other storage devices. Each of the transceivers 13a, 13b, 23a, and 33 may include baseband circuitry and radio frequency (RF) circuitry to process radio frequency signals. When the embodiments are implemented in software, the techniques described herein can be implemented with modules, procedures, functions, entities, and so on, that perform the functions described herein. The modules can be stored in a memory and executed by the processors. The memory can be implemented within a processor or external to the processor, in which those can be communicatively coupled to the processor via various means are known in the art.

The network entity device 30 may be a CN node, i.e., a node in a CN. CN may include LTE CN and/or 5G core (5GC) which includes user plane function (UPF), session management function (SMF), mobility management function (AMF), unified data management (UDM), policy control function (PCF), control plane (CP)/user plane (UP) separation (CUPS), authentication server (AUSF), network slice selection function (NSSF), and the network exposure function (NEF).

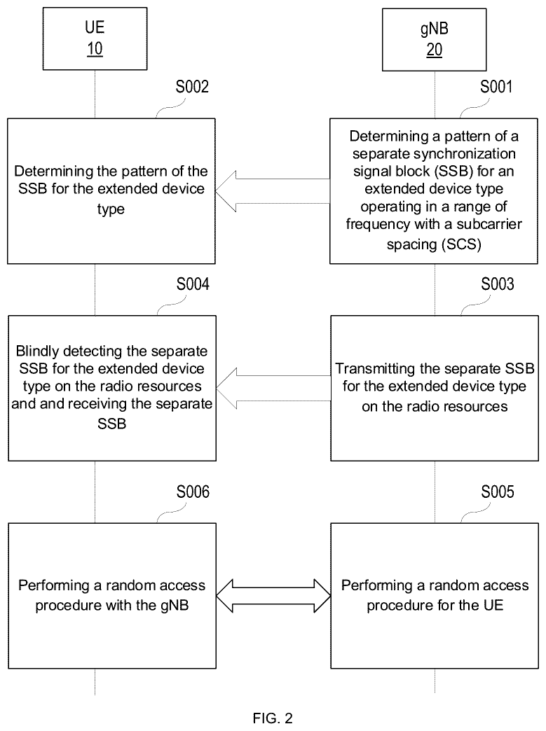

With reference to FIG. 2, an example of a UE 10 in the description may include one of the UE 10a or UE 10b. An example of a base station 20 in the description may include the base station 200a. Note that even though the gNB is described as an example of base station in the following, the radio access method of the disclose may be implemented in any other types of base stations, such as an eNB or a base station for beyond 5G. Uplink (UL) transmission of a control signal or data may be a transmission operation from a UE to a base station. Downlink (DL) transmission of a control signal or data may be a transmission operation from a base station to a UE. The disclosed method is detailed in the following. The UE 10 and the base station 20, such as a gNB, execute the wireless communication method.

FIG. 2 shows an embodiment of the disclosed method. The UE 10 and base station 20 negotiates for information of an extended device type. For example, the UE 10 is a UE belonging to the extended device type.

Patterns of the separate SSB for the extended device type are pre-defined in the telecommunication system conforming to communication standards, such as the 3GPP NR, LTE, or beyond 5G standards. The gNB 20 determines a pattern of a separate synchronization signal block (SSB) for an extended device type operating in a range of frequency with a subcarrier spacing (SCS) (S001). The UE 10 determines the pattern of the SSB for the extended device type, such as a device type of RedCap UE (S002). According to the pattern, radio resources defined by a number of symbols in a time domain and bandwidth in a frequency domain are allocated to the separate SSB for the extended device type.

The gNB 20 transmits the separate SSB for the extended device type on the radio resources (S003). The UE 10 blindly detects for the separate SSB for the extended device type on the radio resources and receives the separate SSB (S004). The separate SSB for the extended device type comprises a primary synchronization signal (PSS), a secondary synchronization signal (SSS), and a physical broadcast channel (PBCH) for the extended device type. The PBCH for the extended device type is separated from the PSS for the extended device type and the SSS for the extended device type in the time domain.

The UE 10 performs a random access procedure with the gNB 20 using the separate SSB for the extended device type (S006). The gNB 20 performs a random access procedure for the UE 10 (S005).

Cell search is the first step for UE to obtain network access. Through cell search, a UE can find an appropriate cell and then access the cell. The cell search process includes frequency sweep, cell detection, broadcast information acquisition, etc. Without the knowledge of cell deployment, a UE has to search for cells within a spectrum range by means of frequency scanning, then obtains the cell information and attempts to initiate cell access. To effectively reduce the synchronization delay and power consumption, 3GPP defines the Synchronization Raster to narrow the search scope through Global Synchronization Channel Number (GSCN). The synchronization raster indicates the frequency positions of the synchronization signal block (SSB) that can be used by the UE for system acquisition when explicit signaling of the position of the synchronization block is not present. The global synchronization raster is defined for all frequencies. Each frequency position of SSB corresponds to a GSCN.

SSB plays a fundamental role in the initial random access. An SSB carries essential information, such as cell ID, time-frequency synchronization, indicating symbol level/slot level/frame timing, cell/beam signal strength/signal quality detection, etc. In NR, SSBs are transmitted in a batch by forming an SSB burst (one SSB per beam) that is used during beam sweeping by changing beam direction for each SSB transmission. Beam sweeping mechanism is used by UE to measure and identify the best beam for a UE. The SSB burst is constrained in a system half-frame where each SSB carries the same cell information but different timing information to enable a UE to achieve the system timing. Each SSB is assigned a certain and unique index in the SSB burst. Indexes of SSBs are numbered from 0 upwards. Upon detection of SSB, the UE can use SSB indexes to determine the position information of SSBs in a set of SSB bursts and determine the timing of SSBs in a half frame carrying system information based on the following table, which describes the candidate position(s) of the SSBs in time slots, where Lₘₐₓ indicates the maximum number of SSBs in one SSB burst.

TABLE 2
SSB candidate location in the time domain according to TS 38.213 V16.5.0

| | | | Candidate | | | | | | |
|---|---|---|---|---|---|---|---|---|---|
| Band | Case | SCS | indexes | Frequency | | | n | Lₘₐₓ | Symbol |
| FR1 | Case A | 15 kHz | {2, 8} + | ≤3 | GHz | For | 0, 1 | 4 | s = 2, 8, 16, |
| | | | 14*n | | | operation | | | 22 |
| | | | | >3 | GHz | without | 0, 1, 2, 3 | 8 | s = 2, 8, 16, |
| | | | | | | shared | | | 22, 30, 36, 44, |
| | | | | | | spectrum | | | 50 |
| | | | | | | channel | | | |
| | | | | | | access | | | |
| | | | | For operation with | | | 0, 1, 2, 3, | 10 | s = 2, 8, 16, |
| | | | | shared spectrum | | | 4 | | 22, 30, 36, 44, |
| | | | | channel access | | | | | 50, 58, 64 |
| | Case B | 30 kHz | {4, 8, 16, | ≤3 | | GHz | 0 | 4 | s = 4, 8, 16, |
| | | | 20} + 28*n | | | | | | 20 |
| | | | | (3 GHz, 6 GHz] | | | 0, 1 | 8 | s = 4, 8, 16, |
| | | | | | | | | | 20, 32, 36, 44, |
| | | | | | | | | | 48 |
| | Case C | 30 kHz | {2, 8} + | ≤3 | GHz | For paired | 0, 1 | 4 | s = 2, 8, 16, |
| | | | 14*n | | | spectrum | | | 22 |
| | | | | >3 | GHz | operation | 0, 1, 2, 3 | 8 | s = 2, 8, 16, |
| | | | | | | without | | | 22, 30, 36, 44, |
| | | | | | | shared | | | 50 |
| | | | | | | spectrum | | | |
| | | | | | | channel | | | |
| | | | | | | access | | | |
| | | | | <1.88 | GHZ | For | 0, 1 | 4 | s = 2, 8, 16, |
| | | | | | | unpaired | | | 22 |
| | | | | ≥1.88 | GHz | spectrum | 0, 1, 2, 3 | 8 | s = 2, 8, 16, |
| | | | | | | operation | | | 22, 30, 36, 44, |
| | | | | | | without | | | 50 |
| | | | | | | shared | | | |
| | | | | | | spectrum | | | |
| | | | | | | channel | | | |
| | | | | | | access | | | |

| | | | | For operation with | | n = 0~9 | 20 | s = 2, 8, 16, |
|---|---|---|---|---|---|---|---|---|
| | | | | shared spectrum | | | | 22, . . . |
| | | | | channel access | | | | |
| FR2 | Case D | 120 kHz | {4, 8, 16, | >6 | GHz | 0~3, 5~8, | 64 | s = 4, 8, 16, |

| | | |
|---|---|---|
| 20} + 28*n | 10~13, | 20, . . . , 524 |
| | 15~18 | |

| | | | | | | | |
|---|---|---|---|---|---|---|---|
| Case E | 240 kHz | {8, 12, 16, | >6 | GHz | 0~3, 5~8 | 64 | s = 8, 12, 16, |

| | |
|---|---|
| 20, 32, 36, | 20, . . . , 492 |
| 40, 44} + | |
| 56*n | |

The variable s in the table represents a start symbol index (i.e., an index of the first symbol) of an SSB candidate location of a candidate SSB within an SSB burst in a half frame. The output of formulas in the column of candidate index of the table is s in the last column, n represent a number of slots, 14 represents 14 symbols in one slot, 28 represents 28 symbols in two slots, and 56 represents 56 symbols in four slots. For example, {2,8}+14*n indicates that candidate indexes of start symbols of candidate SSB within an SSB burst comprise 2+14n and 8+14n, shown as s=2,8,16,22. Similarly, {4,8,16,20}+28*n indicates that candidate indexes of start symbols of candidate SSB within an SSB burst comprise 4+28*n, 8+28*n, 16+28*n, and 20+28*n, shown as s=4,8,16,20 for frequency ≤3 GHz or s=4,8,16,20,32,36,44,48 for frequency in a range of (3 GHZ, 6 GHz]. The periodicity of SSB bursts is referred to as SSB periodicity. In the patterns of candidate SSBs, SSB bursts have 6 options of periodicities, including 5 ms, 10 ms, 20 ms, 40 ms, 80 ms, and 160 ms. The SSB beam within an SSB burst is transmitted within the first half frame (with a length of 5 ms in time) of the SSB periodicity. During cell search performed by a UE, the SSB periodicity is assumed to be 20 ms, and is indicated by a parameter ssb-PeriodicityServingCell in SIB1 or in a parameter ServingCellConfigCommon.

Since physical downlink shared channel (PDSCH) cannot be transmitted on the symbols and physical resource block (PRB) occupied by SSB, system messages, random access response (RAR), paging messages are carried on the PDSCH, it is necessary to inform UE of the locations of the transmitted SSB as soon as possible by a parameter ssb-PositionsInBurst in SIB1 or in ServingCellConfigCommon. Value 0 in the bitmap indicates that the corresponding SSB is not transmitted, while value 1 indicates that the corresponding SSB is transmitted. The following table shows ssb-PositionsInBurst in ServingCellConfigCommonSIB of SIB1 or in ServingCellConfigCommon.

TABLE 3

| | |
|---|---|
| ServingCellConfigCommonSIB::= | SEQUENCE { |

....

| | |
|---|---|
| ssb-PositionsInBurst | SEQUENCE { |
| inOneGroup | BIT STRING (SIZE (8)), |
| groupPresence | BIT STRING (SIZE (8)) OPTIONAL -- Cond FR2-Only |

},

| | |
|---|---|
| ssb-PeriodicityServingCell | ENUMERATED {ms5, ms10, ms20, ms40, ms80, ms160}, |

...,
}

| | |
|---|---|
| ServingCellConfigCommon | ::= SEQUENCE { |

...

| | |
|---|---|
| ssb-PositionsInBurst | CHOICE { |
| shortBitmap | BIT STRING (SIZE (4)), |
| mediumBitmap | BIT STRING (SIZE (8)), |
| longBitmap | BIT STRING (SIZE (64)) |
| } | OPTIONAL, -- Cond AbsFreqSSB |
| ssb-periodicityServingCell | ENUMERATED { ms5, ms10, ms20, ms40, ms80, ms160, spare2, spare1 } |
| | OPTIONAL, -- Need S |

....
}

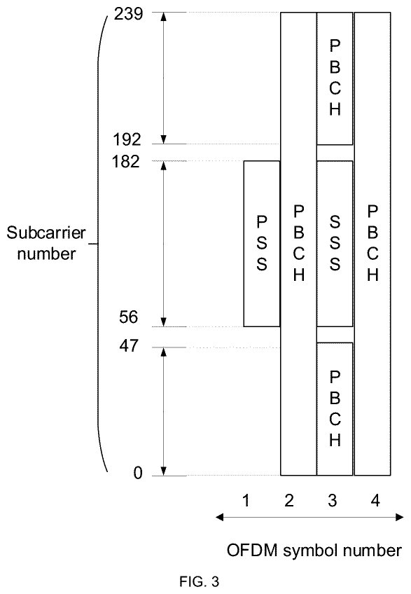

The time-frequency structure of SSB is shown in FIG. 3, including:
Primary Synchronization Signal (PSS), Secondary Synchronization Signal (SSS) and Physical Broadcast Channel (PBCH) are always in consecutive OFDM symbols.
Each SSB occupies 4 OFDM symbols in the time domain and is spread over 240 subcarriers (20 RBs) in the frequency domain.
PSS occupies the first OFDM symbol and spans over 127 subcarriers.
SSS is located in the third OFDM symbol and spans over 127 subcarriers. There are 8 unused subcarriers below SSS and 9 unused subcarriers above SSS.
PBCH occupies two full OFDM symbols (second and fourth) spanning 240 subcarriers and, in the third OFDM symbol, spanning 48 subcarriers below and above SSS. This results in PBCH occupying 576 subcarriers across three OFDM symbols (240+48+48+240=576).
   PBCH demodulation reference signal (DMRS) occupies 144 resource elements (REs) which is one-fourth of total REs, and the remaining REs in PBCH is for PBCH payload (576−144=432 REs). The location of PBCH DMRS depends upon the quantity v (v=N_{ID}^{cell} mod 4).
   Sufficient resources are provided to enable the PBCH to be transmitted with a low bit rate.
   The PBCH carries 24 bits Master Information Block (MIB) messages and 8 bits physical layer information.

The Master Information Block (MIB) provides SSB configuration and the CORESET#0/CSS#0 configuration for monitoring of physical downlink control channel (PDCCH) for SIB1. CORESET stands for control-resource set (CORESET), and CORESET #0 is a CORESET with an index 0. CSS stands for Common Search Space (CSS), and CSS#0 is a CSS with an index 0. SIB stands for system information block (SIB). MIB is shown in the following table.

TABLE 4
MIB message

MIB::= SEQUENCE {

| | |
|---|---|
| systemFrameNumber | BIT STRING (SIZE (6)), |
| subCarrierSpacingCommon | ENUMERATED {scs15or60, scs30or120}, //forSIB1,MSG2/4, |

paging and SIBx

| | |
|---|---|
| ssb-SubcarrierOffset | INTEGER (0..15), |
| dmrs-TypeA-Position | ENUMERATED {pos2, pos3}, |
| pdcch-ConfigSIB1 | PDCCH-ConfigSIB1, |
| cellBarred | ENUMERATED {barred, notBarred}, |
| intraFreqReselection | ENUMERATED {allowed, notAllowed}, |
| spare | BIT STRING (SIZE (1)) |

}

Table 5 shows physical (PHY) level information in PBCH payload.

TABLE 5
8 bit PHY level information: ā_{Ā}, ā_{Ā+1}, ā_{Ā+2},
ā_{Ā+3}, ā_{Ā+4}, ā_{Ā+5}, ā_{Ā+6}, ā_{Ā+7}

| Parameter | Comments |
|---|---|
| ā_{Ā}, ā_{Ā+1}, ā_{Ā+2}, ā_{Ā+3} | 4 least significant bits (LSB) of the SFN. |
| ā_{Ā+4} | Half Frame indication |
| ā_{Ā+5}, ā_{Ā+6}, ā_{Ā+7} | For FR1: |
| | ā_{Ā+5} is the most significant bits (MSB) of k SSB |
| | if L̅ₘₐₓ = 10, |
| | ā_{Ā+6} is reserved. |
| | ā_{Ā+7} is the MSB of the candidate SSB index |
| | if L̅ₘₐₓ = 20 |
| | ā_{Ā+5} is the MSB of k SSB |
| | ā_{Ā+6}, ā_{Ā+7} are the 5th and 4th bits of the |
| | candidate SSB index |
| | else |
| | ā_{Ā+6}, ā_{Ā+7} are reserved |
| | For FR2: |
| | ā_{Ā+5}, ā_{Ā+6}, ā_{Ā+7} are MSB of the candidate |
| | SSB index |

### Time-frequency Structure of a Separate Synchronization Signal Block (SSB)

### Embodiment 1

As shown in FIG. 3, primary synchronization signal (PSS) and secondary synchronization signal (SSS) of the legacy SSB are located in sym0 and sym2 of a legacy SSB, respectively, occupying 127 resource elements (REs) (represented by N_{RE}^{SS,legacy SSB}=127) and about 11 resource block (RBs) in the frequency domain. The sym0 represents a symbol with a symbol index 0, and sym2 represents a symbol with a symbol index 2. Indexes of symbols are numbered from 0 upwards. However, 5 MHz bandwidth can only meet the bandwidth of PSS/SSS and cannot be frequency-division multiplexed (FDMed) with a physical broadcast channel (PBCH). PBCH, PSS, and SSS are located in different symbols. Therefore, a separate SSB reduces the bandwidth of the PBCH symbol. The bandwidth of PBCH is no greater than 11 RBs (e.g., PBCH has a bandwidth equal to 11 RBs or the bandwidth of PSS or SSS).

Since PBCH carries master information block (MIB) messages and PHY layer information, sufficient resources must be allocated to ensure that PBCH is transmitted with a low bit rate. In the legacy SSB, the total PBCH resource (represented by N_{RE,all}^{PBCH,legacy SSB}) is 576 REs where its demodulation reference signal (DMRS) occupies 144 REs. Y symbols (e.g., Y=4 or 5) are assigned to the PBCH of the separate SSB, where Y≥3. PBCH symbols may be interlaced with PSS/SSS symbols or arranged as consecutive PBCH symbols.

For Y=4, the total PBCH resources (represented by N_{RE,all}^{PBCH,separate SSB}, including PBCH DMRS) for a separated SSB are 508˜528 REs which is less than the total PBCH resources of legacy SSB.

For Y=5, the total PBCH resources (represented by N_{RE,all}^{PBCH,separate SSB}, including PBCH DMRS) for a separated SSB are 635˜660 REs which is larger than the total PBCH resources of legacy SSB.

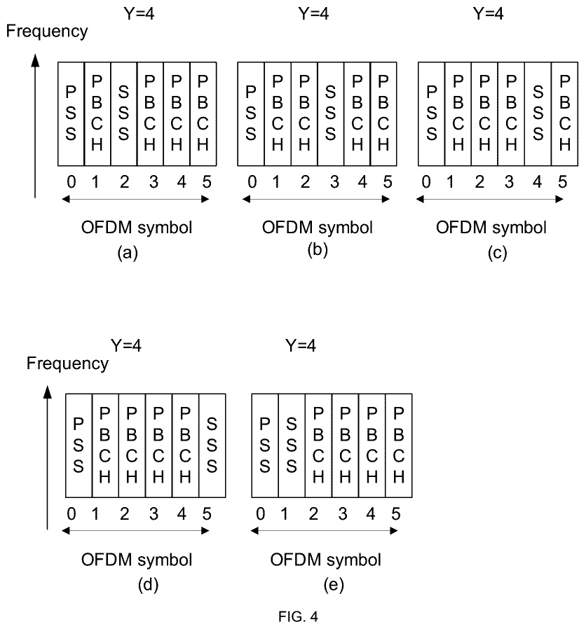

FIG. 4 illustrates a schematic view showing examples of a structure of the separate SSB for the extended device type where four symbols are allocated to physical broadcast channel (PBCH).

The PSS for the extended device type occupies one symbol in the symbols allocated to the separate SSB, the SSS for the extended device type occupies another symbol in the symbols allocated to the separate SSB, and the PBCH for the extended device type occupies remaining symbols in the symbols allocated to the separate SSB.

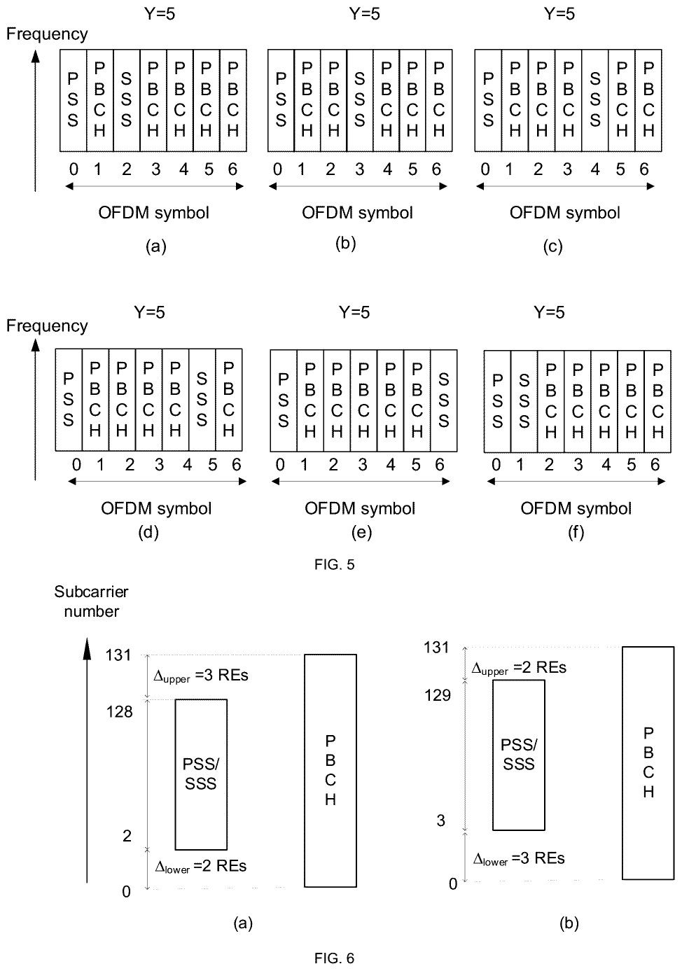

FIGS. 4 and 5 provide examples of separate SSBs. Note that FIGS. 4 and 5 are illustrative not for limiting sizes of PBCH, PSS, and SSS in the frequency domain. Numbering of orthogonal frequency division multiplexing (OFDM) symbols for a separate SSB is relative symbol indexes internal to the separate SSB rather than symbol indexes in a slot. In FIG. 4 (a), (b), (c), (d), and (e), the symbols allocated to the separate SSB comprise six symbols, in which four symbols are allocated to the PBCH for the extended device type. The PSS for the extended device type occupies a first symbol in the symbols allocated to the separate SSB;
the SSS for the extended device type occupies a second symbol, a third symbol, a fourth symbol, a fifth symbol, or a sixth symbol in the symbols allocated to the separate SSB; and
the PBCH for the extended device type occupies the remaining symbols in the symbols allocated to the separate SSB.

FIG. 5 illustrates a schematic view showing examples of a structure of the separate SSB for the extended device type where five symbols are allocated to the physical broadcast channel (PBCH). In FIG. 5 (a), (b), (c), (d), (e), and (f), the symbols allocated to the separate SSB comprise seven symbols, in which five symbols are allocated to the PBCH for the extended device type. The PSS for the extended device type occupies a first symbol in the symbols allocated to the separate SSB;
the SSS for the extended device type occupies a second symbol, a third symbol, a fourth symbol, a fifth symbol, a sixth symbol, or a seventh symbol in the symbols allocated to the separate SSB; and
the PBCH for the extended device type occupies the remaining symbols in the symbols allocated to the separate SSB.

### Embodiment 2

Based on embodiment 1, frequency-domain size of synchronization signals (SS) is Xₛₛ resource elements (REs), and frequency-domain size of a PBCH is X_{PBCH} RES. Xₛₛ and X_{PBCH} are integer variables, each of which represents a number of REs. The SS may comprise PSS or SSS.

Embodiment 2-1: X_{PBCH}=Xₛₛ

In the embodiment, a number X_{PBCH} of resource elements (REs) allocated to the PBCH for the extended device type is equal to a number Xₛₛ of REs allocated to the PSS or the SSS for the extended device type. For example, 127 resource elements (REs) are allocated to each of the PSS, SSS, and PBCH for the extended device type. A center frequency of the PBCH for the extended device type may be aligned with a center frequency of the PSS or the SSS for the extended device type.

$${X}_{PBCH} = {X}_{s s} = {N}_{RE}^{SS , legαcy SSB} ,$$

where N_{RE}^{SS,legacy SSB}=127 REs, or

$${X}_{PBCH} = {X}_{s s} \neq {N}_{R E}^{SS , legαcy SSB} ,$$

where Xₛₛ≤132 REs and Xₛₛ≠127 REs.

N_{RE}^{SS,legacy SSB} is an integer variable, which represents a number of resource elements (REs) allocated to a type of synchronization signals (SS), such as PSS or SSS, of the legacy SSB. The center frequency of PBCH of a separated SBB is aligned with the center frequency of PSS/SSS of the separated SBB, as shown in FIG. 4.

### Embodiment 2-2

In the embodiment, a number X_{PBCH} of resource elements (REs) allocated to the PBCH for the extended device type is not equal to a number Xₛₛ of REs allocated to the PSS or the SSS for the extended device type.

$${X}_{PBCH} \neq {X}_{s s} and {X}_{PBCH} \leq α REs ;$$

where α is an integer variable. For example, α=12* N_{RB}, where N_{RB} is the maximum number of RBs for a single carrier bandwidth. TS38.101 Table 5.3.2-1 provides examples of the maximum number of RBs for a single carrier bandwidth.

### Embodiment 2-2-1

In the embodiment, center frequencies of PBCH and PSS/SSS are aligned as much as possible. The patterns of the separate SSB may comprise different arrangements of PBCH and PSS/SSS when the absolute value of the difference between X_{PBCH} and Xₛₛ is equal to an even number of REs or an odd number of RE(s).
When the absolute value of the difference between X_{PBCH} and Xₛₛ is an even number of RES: The center frequency of PBCH is aligned with the center frequency of PSS/SSS, that is Δᵤₚₚₑᵣ=Δ_{lower}. Δᵤₚₚₑᵣ represents a difference between an upper end of a PBCH and an upper end of a PSS/SSS, and Δ_{lower} represents a difference between a lower end of the PBCH and a lower end of the PSS/SSS.
   When an absolute value of a difference between X_{PBCH} and Xₛₛ is an even number of REs, the center frequency of PBCH for the extended device type is aligned with the center frequency of the PSS or the SSS for the extended device type, so that a difference Δᵤₚₚₑᵣ between an upper end of the PBCH for the extended device type and an upper end of the PSS or the SSS for the extended device type is equal to a difference Δ_{lower} between a lower end of the PBCH for the extended device type and a lower end of the PSS or the SSS for the extended device type.
When the absolute value of the difference between X_{PBCH} and Xₛₛ is an odd number of RE(s): The gNB 20 keeps the difference between Δᵤₚₚₑᵣ and Δ_{lower} as small as possible, such as ±1 RE, that is |Δᵤₚₚₑᵣ−Δ_{lower}|=1 RE. FIG. 6 shows an example where a PBCH has X_{PBCH}=132 and a PSS/SSS has Xₛₛ=127.
   When the absolute value of the difference between X_{PBCH} and Xₛₛ is an odd number of RE or RES, the center frequency of PBCH for the extended device type is located with relative to the center frequency of the PSS or the SSS to minimize a difference between Δᵤₚₚₑᵣ and Δ_{lower}.

### Embodiment 2-2-2

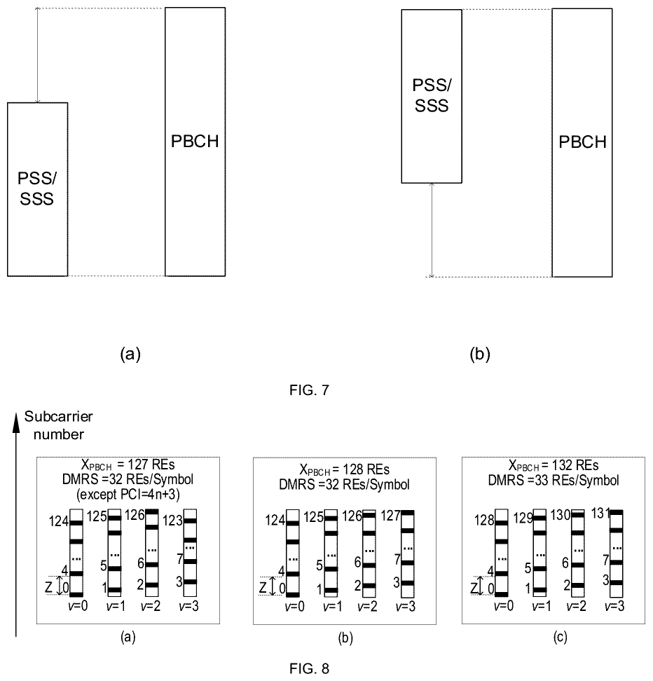

As shown in FIG. 7 (a), the lower end frequency of the PBCH for the extended device type is aligned with the lower end frequency of the PSS or the SSS for the extended device type at the lowest virtual resource block (VRB) and/or physical resource block (PRB) of the PSS or the SSS for the extended device type.

### Embodiment 2-2-3

As shown in FIG. 7(b), the upper-end frequency of the PBCH for the extended device type is aligned with the upper-end frequency of the PSS or the SSS for the extended device type at the highest VRB and/or PRB of the PSS or the SSS for the extended device type.

### PBCH DMRS Pattern

In addition to being used for channel estimation, PBCH demodulation reference signal (DMRS) is also used to indicate part of SSB indexes, which reduces the number of bits in the PBCH. After symbol numbers in a slot and bandwidth for PBCH are determined, the total number of radio resources that can be allocated to the PBCH is determined. Radio resources for PBCH DMRS (referred to as PBCH DMRS resources) and radio resources for PBCH payload (referred to as PBCH payload resources) constitute the total PBCH resources. Hence, a balance between PBCH DMRS resources and PBCH payload resources is desired. The PBCH DMRS pattern of legacy SSB defines an interval of 4 resource elements (REs) between two adjacent DMRSs in a symbol. To reduce pilot interference, a gNB in NR ensures different frequency offset between neighboring cells with the same frequency. PBCH DMRS of legacy SSB has 4 frequency offset values represented by a variable of frequency offset v, which is related to cell ID N_{ID}^{cell} (i.e., v=N_{ID}^{cell} mod 4). Cell ID stands for a cell identifier.

### Embodiment 3: The PBCH DMRS Resources

PBCH demodulation reference signal (DMRS) of the separate SSB has a frequency offset v, where

$$v = {N}_{ID}^{cell} mod M ; \qquad ( 1 )$$

where mod is a modulo operator;
M is a positive integer serving as a divisor (i.e., a modulus) in the formula (1) of modulo operation; and N_{ID}^{cell} is a cell ID associated with the separate SSB.
The formula “v=N_{ID}^{cell} mod 4” is a specific case where modulus M is 4. The modulus M of the separate PBCH DMRS can be:
4 (same as the legacy SSB), or
a value (e.g., 3, 5, or 6) other than 4.

FIG. 8 illustrates a schematic view showing examples of frequency offset where M=4 and Z=4. Z is spacing between two adjacent DMRS. Locations of DMRS are denoted with subcarrier numbers.

It is recommended that X_{PBCH}=k*M, where k is an integer, such as X_{PBCH}=132 or X_{PBCH}=128 when M=4. When the number X_{PBCH} of resource elements (REs) allocated to the PBCH for the extended device type is an integer multiple of M, the number of PBCH DMRS in the neighboring cells will be same, as shown in FIG. 8 (b) and (c).

If X_{PBCH}≠n*M as shown in FIG. 8 (a), the number of PBCH DMRS in cells will be inconsistent. In FIG. 8a for v=3, the number of DMRS is less than the other scenarios with v=0, 1, or 2.

The spacing between two adjacent DMRS in a symbol allocated for the PBCH for the extended device type is Z REs, and Z can be:
4 (same as the legacy SSB), or
a value (e.g., 3, 5, or 6) other than 4.

Z should be greater than or equal to M (i.e., Z≥M). Otherwise, some same-frequency neighboring cells will have the same frequency offset, resulting in frequency interference.

### Embodiment 3-1

Embodiment 3-1 is an example based on embodiment 3, M=4 (i.e., v=N_{ID}^{cell} mod 4), and Z=4.

### Embodiment 3-2

Embodiment 3-2 is an example based on embodiment 3, M=5 (i.e., v=N_{ID}^{cell} mod 5), and Z=5 or 6.

### Embodiment 4: The Pattern of PBCH DMRS of Each Symbol With an SSB is the Same.

The pattern of PBCH DMRS is referred to as a PBCH DMRS pattern. In the embodiment, the PBCH DMRS pattern of each symbol within the separate SSB for the extended device type is the same. Y symbols (e.g., Y=4 or 5) are assigned to the PBCH of the separate SSB. FIG. 9 is an example of a pattern of PBCH DMRS, where Y=4, and the DMRS pattern of each symbol is the same.

### Embodiment 5: The Pattern of PBCH DMRS of Each Symbol With an SSB is Different.

In the embodiment, the PBCH DMRS pattern of each symbol within the separate SSB for the extended device type is not the same. Radio resources allocated to DMRS in the PBCH for the extended device type are referred to as DMRS resources. As more PBCH symbols in the time domain, as shown FIG. 4, multiple PBCH symbols are adjacent. Therefore, DMRS pattern can be appropriately optimized:
(1) The gNB 20 may decrease the DMRS resources and increase the resources of PBCH payload by transmitting sparse DMRS density or DMRS-less in certain PBCH symbol(s). Thus, radio resources allocated to DMRS of the separate SSB are decreased by expanding the DMRS spacing, and radio resources allocated to PBCH payload of the separate SSB are increased.

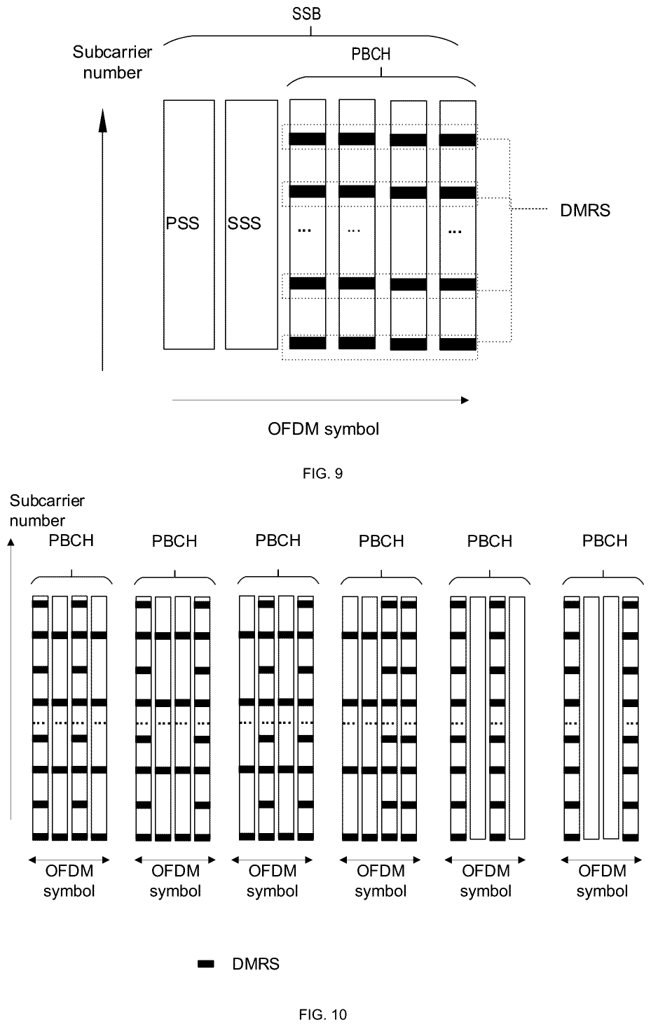

FIG. 10 shows examples of sparse DMRS density and DMRS-less in certain PBCH symbol(s). Optionally, the gNB 20 may transmit sparse DMRS density by expanding the DMRS spacing (e.g., 2Z, 1.5Z). For example, the gNB 20 may determine a new DMRS spacing 2Z or 1.5Z for the separate SSB, where Z is the original DMRS spacing.
(2) Or vice versa, the gNB 20 may increase the DMRS resources and decrease the resources of PBCH payload by increasing DMRS density in certain PBCH symbol(s). Thus, radio resources allocated to DMRS of the separate SSB are increased by reducing the DMRS spacing, and radio resources allocated to PBCH payload of the separate SSB are decreased.

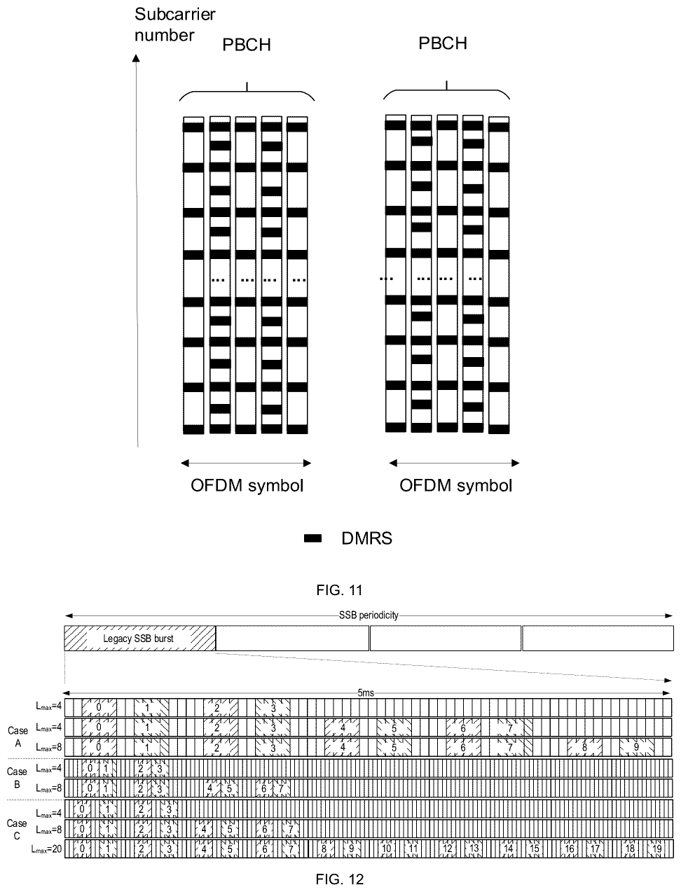

FIG. 11 shows examples of increasing DMRS density in certain PBCH symbol(s). Optionally, the gNB 20 may increase DMRS density by compressing the DMRS spacing. For example, the gNB 20 may determine a new DMRS spacing 0.5Z or 0.25Z for the separate SSB, where Z is the original DMRS spacing.

Since multiple PBCH symbols are adjacent, the joint channel estimation of adjacent PBCH symbols can be performed optionally.

### SSB Candidate Location in the Time Domain

Within a SS burst, for an SSB (i.e., a legacy SSB or a separate SSB), SSB candidate locations in the time domain and the maximum number of SSBs in a wireless frame are associated with the carrier frequency and subcarrier spacing (SCS). With reference to FIG. 12 and table 6, SSB candidate locations in the time domain and the maximum number of SSBs in a wireless frame for legacy SSB in FR1 are shown associated with the carrier frequency and SCS. Note that Lₘₐₓ=10 or 20 is for operation with shared spectrum channel access. In the FIGS. 12, 16, 17, 18, 20, and 21, each smallest block represents a radio resource within one symbol, each slot has 14 symbols (shown as blocks), and each SSB is highlighted and denoted with an SSB index.

TABLE 6
candidate location in time domain for Legacy SSB in FR1

| | | | Candidate | | | | | | |
|---|---|---|---|---|---|---|---|---|---|
| Band | Case | SCS | indexes | Frequency | | | n | Lₘₐₓ | Symbol |
| FR1 | Case A | 15 kHz | {2, 8} + 14*n | ≤3 | GHz | For operation | 0, 1 | 4 | s = 2, 8, 16, |
| | | | | | | without shared | | | 22 |
| | | | | >3 | GHz | spectrum channel | 0, 1, 2, 3 | 8 | s = 2, 8, 16, |
| | | | | | | access | | | 22, 30, 36, 44, |
| | | | | | | | | | 50 |
| | | | | For operation with shared | | | 0, 1, 2, 3, | 10 | s = 2, 8, 16, |
| | | | | spectrum channel access | | | 4 | | 22, 30, 36, 44, |
| | | | | | | | | | 50, 58, 64 |
| | Case B | 30 kHz | {4, 8, 16, | ≤3 GHz | | | 0 | 4 | s = 4, 8, 16, |
| | | | 20} + 28*n | | | | | | 20 |
| | | | | (3 GHz, 6 GHz] | | | 0, 1 | 8 | s = 4, 8, 16, |
| | | | | | | | | | 20, 32, 36, 44, |
| | | | | | | | | | 48 |
| | Case C | 30 kHz | {2, 8} + 14*n | ≤3 | GHz | For paired spectrum | 0, 1 | 4 | s = 2, 8, 16, |
| | | | | | | operation without | | | 22 |
| | | | | >3 | GHz | shared spectrum | 0, 1, 2, 3 | 8 | s = 2, 8, 16, |
| | | | | | | channel access | | | 22, 30, 36, 44, |
| | | | | | | | | | 50 |
| | | | | <1.88 | GHZ | For unpaired | 0, 1 | 4 | s = 2, 8, 16, |
| | | | | | | spectrum operation | | | 22 |
| | | | | ≥1.88 | GHz | without shared | 0, 1, 2, 3 | 8 | s = 2, 8, 16, |
| | | | | | | spectrum channel | | | 22, 30, 36, 44, |
| | | | | | | access | | | 50 |

| | | | |
|---|---|---|---|
| For operation with shared | n = 0~9 | 20 | s = 2, 8, 16, 22, |
| spectrum channel access | | | . . . |

In a half frame, the time slots and symbols used to transmit SSB are predefined. The design considerations include:

Separate SSB and Legacy SSB should not be overlap in the time domain. Embodiments of the disclosure are illustrated in the following.

### Embodiment 6

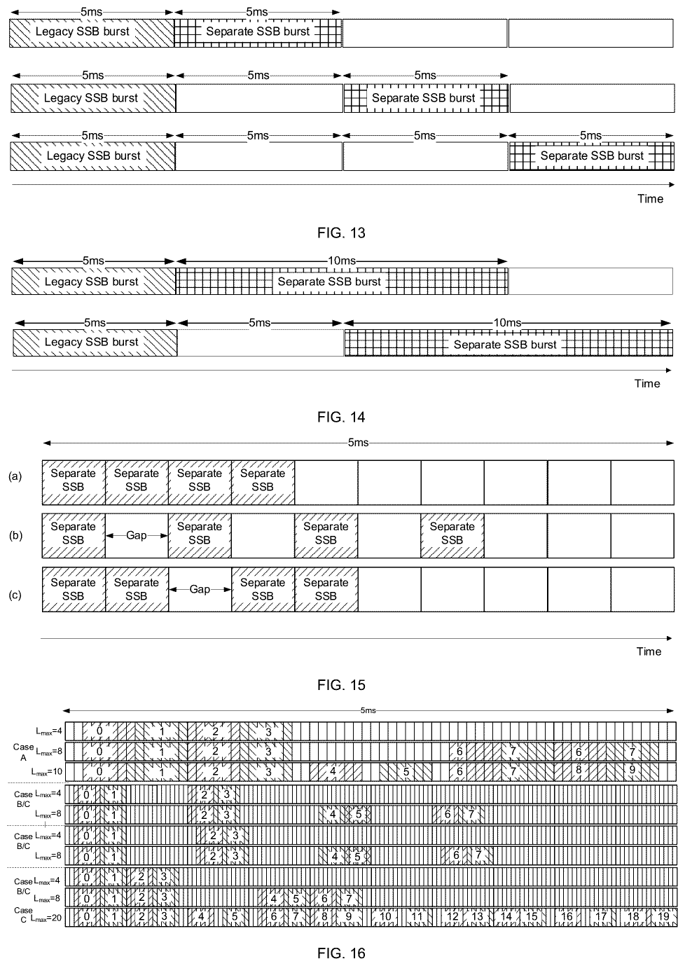

In an embodiment, a separate SSB burst and a legacy SSB burst are transmitted in different half frames or frames. In the patterns of candidate SSBs, the gNB 20 may determine a gap with a duration (n* 5 ms) between a separate SSB burst and a legacy SSB burst, where n is a natural number. For example, n=0,1,2,3, . . . etc. Each half frame has a length of 5 ms in time. FIG. 13 shows an example of candidate locations in time domain for separate SSB burst in a half frame. FIG. 14 shows an example of candidate locations in time domain for separate SSB burst in a frame.

The patterns of the separate SSB may comprise a gap between the separate SSB burst and the legacy SSB burst. The gap has a duration of n half-frames and is pre-defined between the separate SSB burst and the legacy SSB burst, where n may be zero or a positive integer (i.e., n=0,1,2,3, . . . ).
In the pattern determined by the gNB 20, the separate SSB burst follows the legacy SSB burst in a half-frame. In the case, n=0).
In the pattern determined by the gNB 20, a gap with a duration of n half-frames is between the separate SSB burst and the legacy SSB burst, n=1,2,3, . . . etc.

As shown in FIG. 13, in an embodiment, the SSBs of a separate SSB burst are transmitted within a half frame (5 ms). The SSBs of a separate SSB burst are separate SSBs. As shown in FIG. 14, in an embodiment, the SSBs of a separate SSB burst are transmitted within a frame (10 ms).

### Embodiment 7

Embodiment 7 is an example based on embodiment 6, where the candidate slots for SSBs (e.g., the separate SSB and/or the legacy SSB) in an SSB burst may be consecutive or non-consecutive. A candidate slot is a slot in which an SSB may be located, while non-candidate slot is a slot in which no SSB is located. A candidate symbol is a symbol in which an SSB may be located, while non-candidate symbol is a symbol in which no SSB is located. The gap between the separate SSB and the legacy SSB can measured in units of half-frames and represented by a variable N_{gap}^{candidate slot} . That is, the gap between the separate SSB burst and the legacy SSB burst comprises a number N_{gap}^{candidate slot} of half-frames.

FIG. 15 shows an example of candidate locations in time domain for SSBs (e.g., the separate SSB and/or the legacy SSB):
Candidate slots are consecutive (FIG. 15 (a)), or
Candidate slots are non-consecutive with a gap (FIG. 15 (b) or FIG. 15 (c)), but all candidate slots must be within a half frame or a frame. For example, N_{gap}^{candidate slot}=1 slot

### Embodiment 7-1

Embodiment 7-1 is an example based on embodiment 7. In the embodiment, the pattern determined by the gNB 20 may comprise two candidate SSBs per candidate slot. Lₘₐₓ^{separate SSB} indicates the maximum number of SSBs in one separate SSB burst. Lₘₐₓ^{legacy SSB} indicates the maximum number of SSBs in one legacy SSB burst. Candidate slots are slots allocated to one or more candidate SSBs for transmission by the gNB 20. Each of the candidate SSB bursts comprises an SSB burst belonging to the separate SSB burst. In the pattern of the separated SSB burst, each candidate slot comprises two candidate SSBs.
Lₘₐₓ^{separate SSB}:
   For operation with or without shared spectrum channel access where the SSBs of a separate SSB burst are transmitted within a half frame,
      Lₘₐₓ^{separate SSB} is not greater than Lₘₐₓ^{legacy SSB} (i.e., Lₘₐₓ^{separate SSB}≤Lₘₐₓ^{legacy SSB}) and it is recommended that Lₘₐₓ^{separate SSB}=Lₘₐₓ^{legacy SSB}; or
   For operation with or without shared spectrum channel access where the SSBs of a separate SSB burst are transmitted within a frame,
      Lₘₐₓ^{separate SSB} is not greater than Lₘₐₓ^{legacy SSB} (i.e., Lₘₐₓ^{separate SSB}≤Lₘₐₓ^{legacy SSB}) and it is recommended that Lₘₐₓ^{separate SSB}=Lₘₐₓ^{legacy SSB}.

Y indicates a number of symbols assigned to the PBCH of a separate SSB. A candidate SSB is an expected SSB (e.g., a separate SSB or a legacy SSB). FIG. 16 illustrates a schematic view showing examples of the pattern of separate SSBs.
Candidate symbols for Y=4:
   The first symbol of the PBCH of a separate SSB in each of candidate slots is symbol 0 or 2 in the candidate slot:
      Two candidate SSBs in each candidate slot are consecutive. Candidate slots are consecutive or not.
      Two candidate SSBs in each candidate slot are non-consecutive. Candidate slots are consecutive or not.
      Two candidate SSBs in one portion of the candidate slots are consecutive, and two candidate SSBs in another portion of the candidate slots are non-consecutive (as shown in FIG. 16 Lₘₐₓ=10 or 20). Candidate slots are consecutive or not.

The separate SSB burst comprises a maximum number Lₘₐₓ^{separate SSB} of SSBs, the legacy SSB burst comprise a maximum number Lₘₐₓ^{legacy SSB} of SSBs.
Candidate symbols for Y=5, which two candidate SSBs have 14 symbols, so the first symbol of the PBCH of a separate SSB in each of candidate slots is symbol 0.
   For operation with shared spectrum channel access where the SSBs of the separate SSB burst are transmitted within a half frame,
      Lₘₐₓ^{separate SSB}≤Lₘₐₓ^{legacy SSB};
         if the half-frame of the separate SSB burst does not comprise reserved symbols, Lₘₐₓ^{separate SSB} can be equal to Lₘₐₓ^{legacy SSB}. That is, if the half-frame of the separate SSB burst does not comprise reserved symbols, a value of Lₘₐₓ^{separate SSB} has an upper limit equal to a value of Lₘₐₓ^{legacy SSB}. if the half-frame of the separate SSB burst comprises reserved symbols, Lₘₐₓ^{separate SSB} is less than Lₘₐₓ^{legacy SSB}.
         For example, Lₘₐₓ^{separate SSB}=5 in case A.
         For example, Lₘₐₓ^{separate SSB}=10 in case C
   For operation without shared spectrum channel access, or for operation with shared spectrum channel access where the SSBs of the separate SSB burst are transmitted within a frame,
      Lₘₐₓ^{separate SSB} is not greater than Lₘₐₓ^{legacy SSB} and it is recommended that Lₘₐₓ^{separate SSB}=Lₘₐₓ^{legacy SSB}.

### Embodiment 7-2

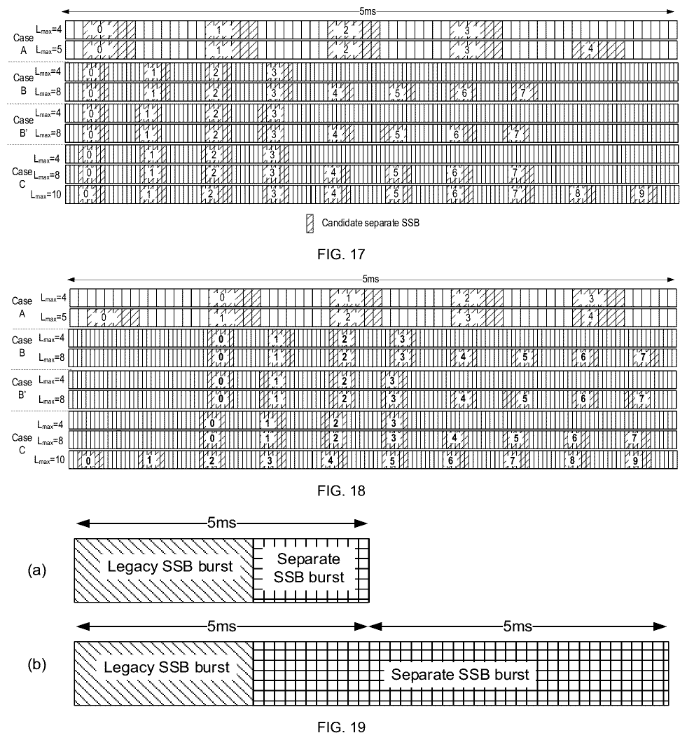

Embodiment 7-2 is an example based on embodiment 7, where the pattern determined by the gNB 20 may comprise one candidate SSB per candidate slot.
Lₘₐₓ^{separate SSB}:
   For the case where the SSBs of the separate SSB burst are transmitted within a half frame:
      For operation with shared spectrum channel access,
         For case A, Lₘₐₓ^{separate SSB} is not greater than 5 and it is recommended that Lₘₐₓ^{separate SSB}=5, since one half-frame only has 5 slots.
         For case C, Lₘₐₓ^{separate SSB} is not greater than 10 and it is recommended that Lₘₐₓ^{separate SSB}=10, since one half-frame only has 10 slots.
      For operation without shared spectrum channel access,
         Lₘₐₓ^{separate SSB} is not greater than Lₘₐₓ^{legacy SSB} and it is recommended that Lₘₐₓ^{separate SSB}=Lₘₐₓ^{legacy SSB}.
         For case A, when Lₘₐₓ^{legacy SSB}=8, Lₘₐₓ^{separate SSB}≤5 (e.g., Lₘₐₓ^{separate SSB}=4 or 5) since one half-frame has 5 slots for 15 kHz SCS. For case C, Lₘₐₓ^{separate SSB}≤Lₘₐₓ^{legacy SSB}.
   For the case where the SSBs of the separate SSB burst are transmitted within a frame:
      Lₘₐₓ^{separate SSB} is not greater than Lₘₐₓ^{legacy SSB} and it is recommended that Lₘₐₓ^{separate SSB=L}ₘₐₓ^{legacy SSB}.
Candidate symbols:
   For Case B:
      The first symbol of all candidate slots is symbol 4, 5 or 6.
         In the pattern determined by the gNB 20, an index of a candidate symbol may be 4+14*n, 5+14*n or 6+14*n (as shown in FIG. 17 Case B).
      The first symbol of even candidate slots is symbol 4, and the first symbol of odd candidate slots is symbol 2. (as shown in FIG. 17 Case B′).
         In the pattern determined by the gNB 20, an index of a candidate symbol may be {4, 16}+28*n
   For Case A/C:
      The first symbol of all candidate slots is symbol 2, 3, 4, 5 or 6.
         In the pattern determined by the gNB 20, an index of a candidate symbol may be 2+14*n, 3+14*n, 4+14*n, 5+14*n or 6+14*n

### Embodiment 7-2-1

Embodiment 7-2-1 is an example based on embodiment 7-2, where the candidate slots start from the first slot of a half frame (5 ms). FIG. 17 illustrates a schematic view showing examples of candidate locations in candidate slots for separate SSB.

For example, the gNB 20 may determine the pattern of a separate SSB according to the following table.

TABLE 7

| | | Candidate | | | | | |
|---|---|---|---|---|---|---|---|
| | SCS | indexes | Frequency | | | n | Lₘₐₓ |
| Case A | 15 kHz | 2 + 14*n | ≤3 | GHz | For paired spectrum | 0~3 | 4 |
| | | | >3 | GHz | operation without | 0~4 | 5 |
| | | | | | shared spectrum | | |
| | | | | | channel access | | |
| | | | For operation with shared | | | 0~4 | 5 |
| | | | spectrum channel access | | | | |
| Case B | 30 kHz | 4 + 14*n | ≤3 GHz | | | 0~3 | 4 |
| | | | >3 GHz | | | 0~7 | 8 |
| Case B′ | 30 kHz | {4, 16} + | ≤3 GHz | | | 0~1 | 4 |
| | | 28*n | >3 GHz | | | 0~3 | 8 |
| Case C | 30 kHz | 2 + 14*n | ≤3 | GHz | For paired spectrum | 0~4 | 4 |
| | | | >3 | GHz | operation without | 0~7 | 8 |
| | | | | | shared spectrum | | |
| | | | | | channel access | | |
| | | | <1.88 | GHZ | For unpaired spectrum | 0~4 | 4 |
| | | | ≥1.88 | GHz | operation without | 0~7 | 8 |
| | | | | | shared spectrum | | |
| | | | | | channel access | | |

| | | |
|---|---|---|
| For operation with shared | 0~9 | 10 |
| spectrum channel access | | |

### Embodiment 7-2-2

Embodiment 7-2-2 is an example based on embodiment 7-2, where the candidate slots do not always start from the first slot of a half frame (5 ms) or the first slot of a frame. FIG. 18 illustrates a schematic view showing examples of candidate locations in candidate slots for separate SSB.

For example, the gNB 20 may determine the pattern of a separate SSB according to the following, where the Lₘₐₓ represents Lₘₐₓ^{separate SSB}.
For case B or C with Lₘₐₓ=4 in a table of SSB candidate location, the candidate slots of the separate SSB are different from candidate slots of the legacy SSB.
For case A with Lₘₐₓ=8 and Lₘₐₓ=4 in the table of SSB bursts candidate location, the candidate slots of separate SSB overlap partially with slots of the legacy SSB.
Fore case A with Lₘₐₓ=10 and Lₘₐₓ=5 in the table of SSB bursts candidate location, the candidate slots of separate SSB start from the first slot of a half frame (5 ms).

### Embodiment 8

In the embodiment, separate SSBs are located in one or more the remaining slots of the half frame that transmits the legacy SSBs. In the embodiment, separate SSBs are located in one or more the remaining slots of the frame that transmits the legacy SSBs.

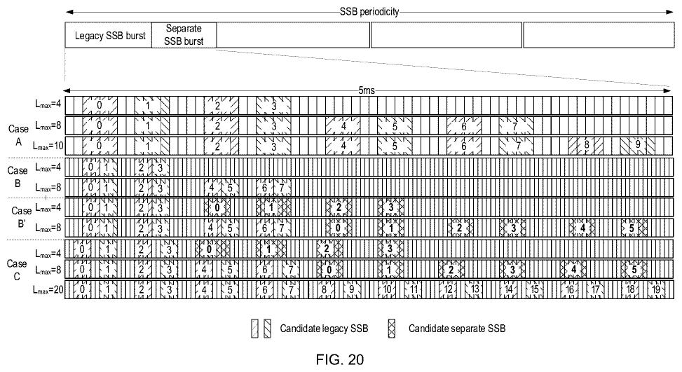

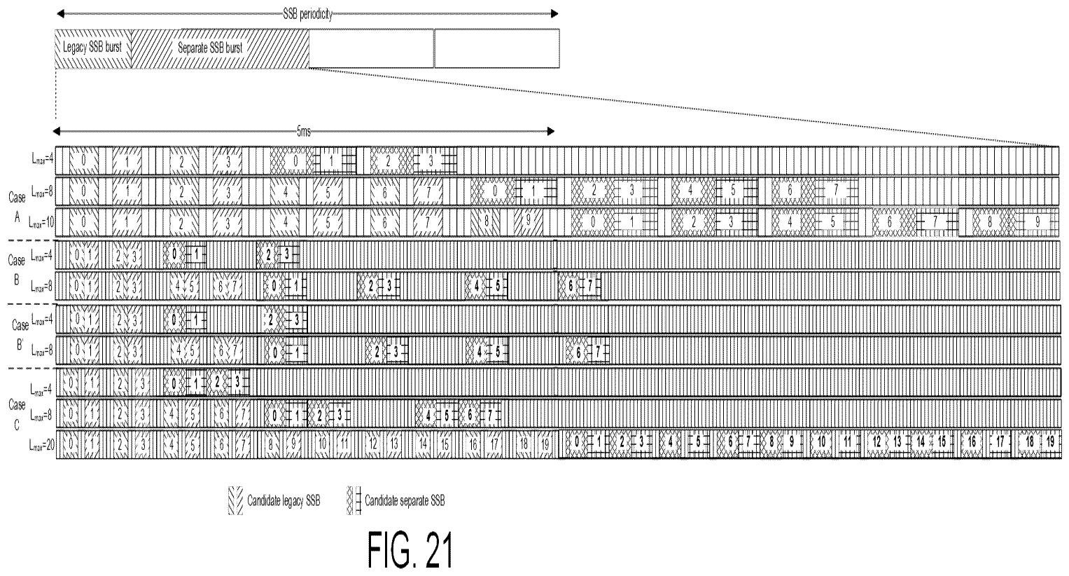

Candidate slots: In the same half fame as the half frame that transmits the legacy SSBs, separate SSBs can be located in the remaining slots which do not have the candidate legacy SSBs. If the remaining slots cannot include the whole separate SSBs, the remaining separate SSBs can be located in consecutive slots in consecutive half frames. FIG. 19 shows examples of candidate locations in candidate slots for the separate SSB in one half frame (FIG. 19 (a)) or in consecutive half frames (FIG. 19 (b). FIG. 20 provides examples of candidate locations in candidate slots for the separate SSB in one half frame. FIG. 21 provides examples of candidate locations in candidate slots for the separate SSB in consecutive half frames.

One or two candidate SSBs can be located in one candidate slot, and the candidate symbols can be arranged based on Embodiment 7-1 or 7-2. FIG. 21 illustrates a schematic view showing examples of candidate locations in time domain for separate SSB.

For the case in FIGS. 19 (a) and 20, when the separate SSB and the legacy SSB are located in the same half frame,

(1) For operation with shared spectrum channel access:
There is no remaining slot for locating the separate SSB within the same half frame (5 ms), so separate SSB must be located in a half frame (5 ms) different from a half frame allocated for the legacy SSB burst.

(2) For operation without shared spectrum channel access:
In the pattern determined by the gNB 20, Lₘₐₓ^{separate SSB} is no greater than twice of the remaining slots (i.e., Lₘₐₓ^{separate SSB}≤the remaining slots*2) of the half frame allocated for the legacy SSB burst if two candidate SSBs is located in one candidate slot.
In the pattern determined by the gNB 20, Lₘₐₓ^{separate SSB} is no greater than the remaining slots (i.e., Lₘₐₓ^{separate SSB}≤the remaining slots) of the half frame allocated for the legacy SSB burst if one candidate SSB is located in one candidate slot.

For the case in FIGS. 19 (b) and 21, when the separate SSB and the legacy SSB are located in the same frame, Lₘₐₓ^{separate SSB}is not greater than Lₘₐₓ^{legacy SSB}and it is recommended that Lₘₐₓ^{separate SSB}=Lₘₐₓ^{legacy SSB}, except:
For operation with shared spectrum channel access and SCS=30 kHz, if one candidate SSB is located in one candidate slot: Lₘₐₓ^{separate SSB}≤10 and it is recommended that Lₘₐₓ^{separate SSB}=10 since only 10 remaining slots in the same frame, which is 10 milliseconds (ms).

In summary, Lₘₐₓ^{separate SSB} of the separate SSB bursts for different conditions associated with, frame/half frame allocation, operation with/without shared spectrum channel access, and SCSs is shown in the following Table 8.

TABLE 8

| Frame/ half | | For | | | | |
|---|---|---|---|---|---|---|
| fame | | operation | For | | | |
| allocation for | | without | operation | | | |
| transmission | The number N | shared | with shared | | | |
| of one | of candidate | spectrum | spectrum | | | |
| separate | SSBs per | channel | channel | | | |
| SSB burst | candidate slot | access | access | Lₘₐₓ^{Separate SSB} | Recommended | SCS |
| one half | 2 candidate | Y | | Lₘₐₓ^{separate SSB} ≤ | Lₘₐₓ^{separate SSB} = | 15 kHz/ |
| frame | SSBs | | Y | Lₘₐₓ^{legacy SSB} | Lₘₐₓ^{legacy SSB} | 30 kHz |
| | 1 candidate | Y | | Lₘₐₓ^{separate SSB} ≤ 5 | Lₘₐₓ^{separate SSB} = 4 | 15 kHz |
| | SSB | | | Lₘₐₓ^{separate SSB} ≤ | Lₘₐₓ^{separate SSB} = | 30 KHZ |
| | | | | Lₘₐₓ^{legacy SSB} | Lₘₐₓ^{legacy SSB} | |
| | | | Y | Lₘₐₓ^{separate SSB} ≤ 5 | Lₘₐₓ^{separate SSB} = 5 | 15 kHz: |
| | | | | Lₘₐₓ^{separate SSB} ≤ 10 | Lₘₐₓ^{separate SSB} = 10 | 30 KHZ |
| One frame | 2 candidate | Y | | Lₘₐₓ^{separate SSB} ≤ | Lₘₐₓ^{separate SSB} = | 15 kHz/ |
| | SSBs | | Y | Lₘₐₓ^{legacy SSB} | Lₘₐₓ^{legacy SSB} | 30 kHz |
| | 1 candidate | Y | | | | |
| | SSB | | Y | | | |
| One half | 2 candidate | Y | | Lₘₐₓ^{separate SSB} ≤ the | Lₘₐₓ^{separate SSB} = the | 15 kHz/ |
| frame | SSBs | | Y | remaining slots of | remaining slots of | 30 kHz |
| shared with | | | | the half frame* 2 | the half frame * 2 | |
| legacy SSB | 1 candidate | Y | | Lₘₐₓ^{separate SSB} ≤ the | Lₘₐₓ^{separate SSB} = the | |
| burst | SSB | | Y | remaining slots of | remaining slots of | |
| | | | | the half frame | the half frame | |
| One frame | 2 candidate | Y | | Lₘₐₓ^{separate SSB} ≤ | Lₘₐₓ^{separate SSB} ≤ | 15 kHz/ |
| shared with | SSBs | | Y | Lₘₐₓ^{legacy SSB} | Lₘₐₓ^{legacy SSB} | 30 kHz |
| legacy SSB | 1 candidate | Y | | Lₘₐₓ^{separate SSB} ≤ | Lₘₐₓ^{separate SSB} ≤ | 15 kHz/ |
| burst | SSB | | | Lₘₐₓ^{legacy SSB} | Lₘₐₓ^{legacy SSB} | 30 kHz |
| | | | Y | Lₘₐₓ^{separate SSB} ≤ | Lₘₐₓ^{separate SSB} ≤ | 15 kHz |
| | | | | Lₘₐₓ^{legacy SSB} | Lₘₐₓ^{legacy SSB} | |
| | | | | Lₘₐₓ^{separate SSB} ≤ 10 | Lₘₐₓ^{separate SSB} = 10 | 30 kHz |

### SSB Periodicity

A UE (such as the UE 10) can be provided per serving cell by ssb-periodicityServingCell (e.g., 5 ms, 10 ms, 20 ms, 40 ms, 80 ms, 160 ms) in SIB1 or in ServingCellConfigCommon a periodicity of the half frames for reception of legacy SSBs for the serving cell. If the UE is not informed of a periodicity of the half frames for receptions of legacy SSBs, the UE assumes a periodicity of a half frame. A UE (such as the UE 10) assumes that the periodicity is same for all legacy SSBs in the serving cell. For initial cell selection, a UE (such as the UE 10) may assume that legacy SSBs occur in half frames with a periodicity of 2 frames. The parameters ssb-PeriodicityServingCell and ssb-periodicityServingCell are shown in the following table.

TABLE 9
ServingCellConfigCommonSIB::= SEQUENCE {
...,

| | |
|---|---|
| ssb-PositionsInBurst | SEQUENCE { |
| inOneGroup | BIT STRING (SIZE (8)), |
| groupPresence | BIT STRING (SIZE (8)) OPTIONAL -- Cond FR2-Only |

},

| | |
|---|---|
| ssb-PeriodicityServingCell | ENUMERATED {ms5, ms10, ms20, ms40, ms80, ms160}, |

...
}
ServingCellConfigCommon ::= SEQUENCE {
...

| | |
|---|---|
| ssb-PositionsInBurst | CHOICE { |
| shortBitmap | BIT STRING (SIZE (4)), |
| mediumBitmap | BIT STRING (SIZE (8)), |
| longBitmap | BIT STRING (SIZE (64)) |

} OPTIONAL, -- Cond AbsFreqSSB

| | |
|---|---|
| ssb-periodicityServingCell | ENUMERATED { ms5, ms10, ms20, ms40, ms80, ms160, spare2, spare1 } |

OPTIONAL, -- Need S
....
}

### Embodiment 9: Same Periodicity as the Legacy SSB

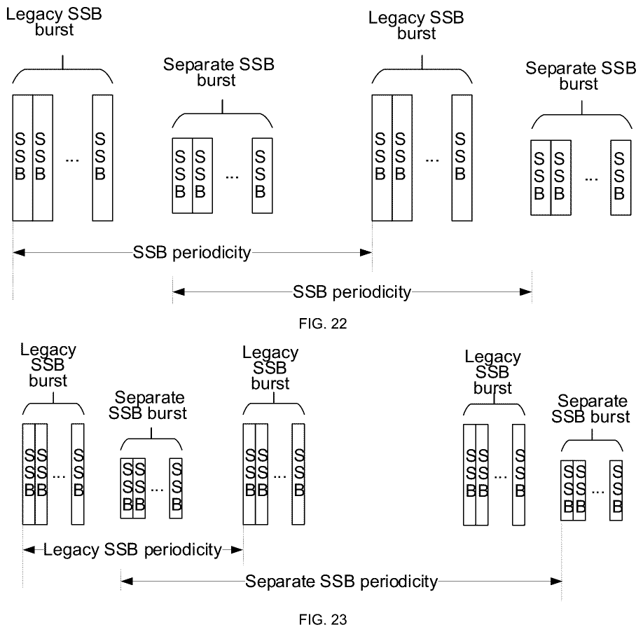

In the embodiment, the separate SSB has a periodicity the same as the periodicity of the legacy SSB, where the periodicity of the separate SSB is referred to as separate SSB periodicity, and the periodicity of the legacy SSB is referred to as legacy SSB periodicity (i.e., the separate SSB periodicity=the legacy SSB periodicity). The separate SSB periodicity is a periodicity of the half frames in which SSBs belonging to the separate SSB are located. The legacy SSB periodicity is a periodicity of the half frames in which SSBs belonging to the legacy SSB are located. The separate SSB reuses the same periodicity and the pattern of the legacy SSB. FIG. 22 illustrates a schematic view showing examples of SSB periodicity.

### Embodiment 10: Different Periodicity From the Legacy SSB

In the embodiment, separate SSB has a periodicity different from the periodicity of the legacy SSB (i.e., the separate SSB periodicity≠the legacy SSB periodicity). FIG. 23 illustrates a schematic view showing examples of SSB periodicity.
(1) The separate SSB periodicity is provided separately from the legacy SSB periodicity. Therefore, a UE can be provided by a separate parameter that indicates a periodicity of the half frames for reception of separate SSBs for the serving cell. The maximum periodicity can be expanded to 320 ms or 640 ms.

For example, in addition to the parameters ssb-PeriodicityServingCell and ssb-periodicityServingCell, the gNB 20 sends to the UE 10 SIB1 ServingCellConfigCommonSIB comprising a parameter separateSSB-PeriodicityServingCell for the separate SBB and/or ServingCellConfigCommon comprising a parameter separateSSB-PeriodicityServingCell for the separate SBB, as shown in the following table. The configuration of the separated SSB may be indicated by a parameter separateSSB-PeriodicityServingCell that indicates a periodicity of the half frames in which SSBs belonging to the separate SSB are located, for reception of separate SSBs for the serving cell.

TABLE 10
ServingCellConfigCommonSIB::= SEQUENCE {
...,

| | |
|---|---|
| ssb-PositionsInBurst | SEQUENCE { |
| inOneGroup | BIT STRING (SIZE (8)), |
| groupPresence | BIT STRING (SIZE (8)) OPTIONAL -- Cond FR2-Only |

},

| | |
|---|---|
| ssb-PeriodicityServingCell | ENUMERATED {ms5, ms10, ms20, ms40, ms80, ms160}, |
| separateSSB-PeriodicityServingCell | ENUMERATED {ms5, ms10, ms20, ms40, ms80, ms160, |

ms320, ms640},
...
}

| | |
|---|---|
| ServingCellConfigCommon | ::= SEQUENCE { |

...

| | |
|---|---|
| ssb-PositionsInBurst | CHOICE { |
| shortBitmap | BIT STRING (SIZE (4)), |
| mediumBitmap | BIT STRING (SIZE (8)), |
| longBitmap | BIT STRING (SIZE (64)) |

} OPTIONAL, -- Cond AbsFreqSSB

| | |
|---|---|
| ssb-periodicityServingCell | ENUMERATED { ms5, ms10, ms20, ms40, ms80, ms160, spare2, spare1 } |

OPTIONAL, -- Need S

| | |
|---|---|
| separateSSB-PeriodicityServingCell | ENUMERATED {ms5, ms10, ms20, ms40, ms80, ms160, |

ms320, ms640},
....
}

(2) The separate SSB periodicity=Q*the legacy SSB periodicity, where Q is an integer (such as 1,2,3,4,5,6,7,8, etc.) or a non-integer (such as 1.5, 2.5, 3.5, 4.5, 5.5, etc.). Therefore, a UE (e.g., UE 10) can be provided the n value or a periodicity (as shown above) of the half frames for reception of separate SSBs for the serving cell by a separate field.

For example, in addition the to parameters ssb-PeriodicityServingCell and ssb-periodicityServingCell, the gNB 20 sends to the UE 10 SIB1 ServingCellConfigCommonSIB comprising Q in a parameter multiple-SeparateSSBPeriodicity for the separate SBB and/or ServingCellConfigCommon comprising (Q*the legacy SSB periodicity) in a parameter for the separate SBB, as shown in the following table. That is, the periodicity of the separate SSB is an integer Q multiple of the periodicity of the legacy SSB, the configuration of the separated SSB may be indicated by a parameter that indicates the periodicity of the separate SSB or a parameter that indicates the integer Q.

TABLE 11
ServingCellConfigCommonSIB::= SEQUENCE {
...,

| | |
|---|---|
| ssb-PositionsInBurst | SEQUENCE { |
| inOneGroup | BIT STRING (SIZE (8)), |
| groupPresence | BIT STRING (SIZE (8)) OPTIONAL -- Cond FR2-Only |

},

| | |
|---|---|
| ssb-PeriodicityServingCell | ENUMERATED {ms5, ms10, ms20, ms40, ms80, ms160}, |
| multiple-SeparateSSBPeriodicity | INTEGER (1..8), |

...
}

| | |
|---|---|
| ServingCellConfigCommon | ::= SEQUENCE { |

...

| | |
|---|---|
| ssb-PositionsInBurst | CHOICE { |
| shortBitmap | BIT STRING (SIZE (4)), |
| mediumBitmap | BIT STRING (SIZE (8)), |
| longBitmap | BIT STRING (SIZE (64)) |
| } | OPTIONAL, -- Cond AbsFreqSSB |
| ssb-periodicityServingCell | ENUMERATED { ms5, ms10, ms20, ms40, ms80, ms160, spare2, spare1 } |
| | OPTIONAL, -- Need S |
| multiple-SeparateSSBPeriodicity | INTEGER (1..8), |

....
}

### Indication of the Actually Transmitted Separate SSBs

In the same way, PDSCH cannot be transmitted on the symbol and PRB occupied by separate SSB. A UE can be provided the system information (e.g., SIB1 or SIBx) and/or a higher-layer parameter, which includes an indication for receptions of the actually transmitted separate SSB. The indication indicates the pattern including locations, periodicity and other information associated with the separated SSB.

### Embodiment 11: The Transmitted Separate SSBs is Associated With the Transmitted Legacy SSBs, Where Their Indexes are the Same

In the embodiment, the pattern including locations, periodicity and other information associated with the transmitted separate SSBs are associated with the transmitted legacy SSBs. That is, slot indexes of the transmitted separate SSBs are the same as slot indexes of the transmitted legacy SSBs.
The gNB 20 reuses the existing parameters “ssb-PositionsInBurst” in SIB1 or in ServingCellConfigCommon to indicate the actually transmitted separate SSB. In the embodiment, the configuration of the separated SSB is indicated by a parameter ssb-PositionsInBurst in SIB1 or in ServingCellConfigCommon to indicate the actually transmitted separate SSB.
The gNB 20 uses a new high-layer parameter to indicate the actually transmitted separate SSB (as shown below).

If Lₘₐₓ^{separate SSB}<Lₘₐₓ^{legacy SSB}, the UE (e.g., UE 10) ignores configuration or the pattern associated with the rightmost bits of the transmitted legacy SSBs, which exceeds Lₘₐₓ^{separate SSB}.

### Embodiment 12: The Transmitted Separate SSBs is Not Associated With the Transmitted Legacy SSBs, Where Their Indexes are Different.

A UE can be provided by a field in the system information (e.g., SIB1 or SIBx) or the higher layer parameter, which indicates the locations of the transmitted separate SSBs in an SSB burst. In the embodiment, slot indexes of the separate SSBs are disassociated from slot indexes of transmitted legacy SSBs, the configuration of the separated SSB is indicated by a parameter that indicates the actually transmitted separate SSB.

For example, the gNB 20 sends to the UE 10 SIB1 ServingCellConfigCommonSIB comprising a parameter ssb-PositionsInBurstForseparateSSB indicating the location of the transmitted separate SBB and/or ServingCellConfigCommon comprising a parameter ssb-PositionsInBurstForseparateSSB indicating the location of the transmitted separate SBB, as shown in the following table.

TABLE 12

| | |
|---|---|
| ServingCellConfigCommonSIB::= | SEQUENCE { |

....

| | |
|---|---|
| ssb-PositionsInBurstForseparateSSB | BIT STRING (SIZE (8)), |

...,
}
ServingCellConfigCommon ::= SEQUENCE {
...

| | |
|---|---|
| ssb-PositionsInBurstForseparateSSB | BIT STRING (SIZE (8)), |

}

When maximum number of separate SSB per half frame is smaller than 8, only the corresponding leftmost bits not exceeding Lₘₐₓ^{separate SSB} are valid, and the UE ignores the other rightmost bits that exceeds Lₘₐₓ^{separate SSB}. Indexes of bits are numbered from zero upwards. Value 0 in the bitmap ssb-PositionsInBurstForseparateSSB indicates that the corresponding SSB is not transmitted while value 1 indicates that the corresponding SSB is transmitted. For example, PositionsInBurstForseparateSSB=11111000 is a bit map, the first 5 1's represent the first 5 SSBs in the SSB burst which will be actually transmitted by the gNB 20.

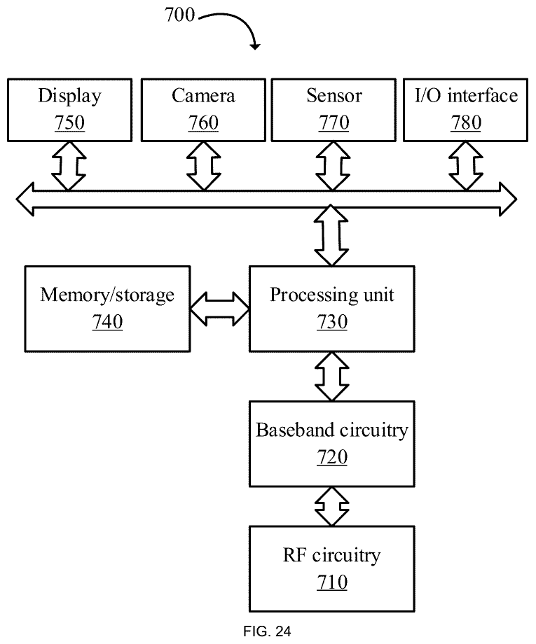

FIG. 24 is a block diagram of an example system 700 for wireless communication according to an embodiment of the present disclosure. Embodiments described herein may be implemented into the system using any suitably configured hardware and/or software. FIG. 24 illustrates the system 700 including a radio frequency (RF) circuitry 710, a baseband circuitry 720, a processing unit 730, a memory/storage 740, a display 750, a camera 760, a sensor 770, and an input/output (I/O) interface 780, coupled with each other as illustrated.

The processing unit 730 may include circuitry, such as, but not limited to, one or more single-core or multi-core processors. The processors may include any combinations of general-purpose processors and dedicated processors, such as graphics processors and application processors. The processors may be coupled with the memory/storage and configured to execute instructions stored in the memory/storage to enable various applications and/or operating systems running on the system.

The radio control functions may include, but are not limited to, signal modulation, encoding, decoding, radio frequency shifting, etc. In some embodiments, the baseband circuitry may provide for communication compatible with one or more radio technologies. For example, in some embodiments, the baseband circuitry may support communication with 5G NR, LTE, an evolved universal terrestrial radio access network (EUTRAN) and/or other wireless metropolitan area networks (WMAN), a wireless local area network (WLAN), a wireless personal area network (WPAN). Embodiments in which the baseband circuitry is configured to support radio communications of more than one wireless protocol may be referred to as multi-mode baseband circuitry. In various embodiments, the baseband circuitry 720 may include circuitry to operate with signals that are not strictly considered as being in a baseband frequency. For example, in some embodiments, baseband circuitry may include circuitry to operate with signals having an intermediate frequency, which is between a baseband frequency and a radio frequency.

In various embodiments, the system 700 may be a mobile computing device such as, but not limited to, a laptop computing device, a tablet computing device, a netbook, an ultrabook, a smartphone, etc. In various embodiments, the system may have more or less components, and/or different architectures. Where appropriate, the methods described herein may be implemented as a computer program. The computer program may be stored on a storage medium, such as a non-transitory storage medium.

The embodiment of the present disclosure is a combination of techniques/processes that can be adopted in 3GPP specification to create an end product.

If the software function unit is realized and used and sold as a product, it can be stored in a readable storage medium in a computer. Based on this understanding, the technical plan proposed by the present disclosure can be essentially or partially realized as the form of a software product. Or, one part of the technical plan beneficial to the conventional technology can be realized as the form of a software product. The software product in the computer is stored in a storage medium, including a plurality of commands for a computational device (such as a personal computer, a server, or a network device) to run all or some of the steps disclosed by the embodiments of the present disclosure. The storage medium includes a USB disk, a mobile hard disk, a read-only memory (ROM), a random access memory (RAM), a floppy disk, or other kinds of media capable of storing program codes.

The disclosure provides a wireless communication method, a base station, and a user equipment (UE) for processing a synchronization signal block (SSB) for an extended device type, including but not limited to a device type of RedCap UE. The SSB for the extended device type may be transmitted by the base station and received by the UE during a random access procedure.

While the present disclosure has been described in connection with what is considered the most practical and preferred embodiments, it is understood that the present disclosure is not limited to the disclosed embodiments but is intended to cover various arrangements made without departing from the scope of the broadest interpretation of the appended claims.

1. A wireless communication method, executable in a base station, comprising:
determining a pattern of a separate synchronization signal block (SSB) for an extended device type, wherein radio resources defined by a number of symbols in a time domain and bandwidth in a frequency domain are allocated to the separate SSB for the extended device type; and
transmitting the separate SSB for the extended device type on the radio resources;
wherein the separate SSB for the extended device type comprises a primary synchronization signal (PSS), a secondary synchronization signal (SSS), and a physical broadcast channel (PBCH) for the extended device type;
wherein a separate SSB burst and a legacy SSB burst are transmitted in different half frames or frames, wherein the separate SSB burst is formed by several separate SSBs.

2. The method of claim 1, wherein the extended device type comprises a device type of reduced capability user equipment (RedCap UE).

3. The method of claim 1, further comprises:
determining a gap with a duration (n*5 ms) between the separate SSB burst and the legacy SSB burst, where n is a natural number.

4-33. (canceled)

34. The method of claim 1, wherein the separate SSB has a periodicity the same as periodicity of a legacy SSB.

35. The method of claim 1, wherein the separate SSB has a periodicity different from periodicity of a legacy SSB, configuration of the separated SSB is indicated by a parameter.

36. The method of claim 1, wherein physical downlink shared channel (PDSCH) transmitted does not overlap with symbols and physical radio resources (PRBs) of the separate SSB.

37. The method of claim 1, wherein the transmitted separate SSB is associated with legacy SSBs, wherein indexes of the transmitted separate SSB are the same as indexes of the legacy SSBs.

38-39. (canceled)

40. A base station comprising:
a processor, configured to call and run a computer program stored in a memory, to cause a device in which the processor is installed to execute a wireless communication method comprising:
determining a pattern of a separate synchronization signal block (SSB) for an extended device type, wherein radio resources defined by a number of symbols in a time domain and bandwidth in a frequency domain are allocated to the separate SSB for the extended device type; and
transmitting the separate SSB for the extended device type on the radio resources;
wherein the separate SSB for the extended device type comprises a primary synchronization signal (PSS), a secondary synchronization signal (SSS), and a physical broadcast channel (PBCH) for the extended device type;
wherein a separate SSB burst and a legacy SSB burst are transmitted in different half frames or frames, wherein the separate SSB burst is formed by several separate SSBs.

41-44. (canceled)

45. A wireless communication method, executable in a user equipment (UE), comprising:
determining a pattern of a separate synchronization signal block (SSB) for an extended device type, wherein radio resources defined by a number of symbols in a time domain and bandwidth in a frequency domain are allocated to the separate SSB for the extended device type; and
receiving the separate SSB for the extended device type on the radio resources;
wherein the separate SSB for the extended device type comprises a primary synchronization signal (PSS), a secondary synchronization signal (SSS), and a physical broadcast channel (PBCH) for the extended device type;
wherein a separate SSB burst and a legacy SSB burst are transmitted in different half frames or frames, wherein the separate SSB burst is formed by several separate SSBs.

46. The method of claim 45, wherein the extended device type comprises a device type of reduced capability user equipment (RedCap UE).

47. The method of claim 45, further comprises:
determining a gap with a duration (n*5 ms) between the separate SSB burst and the legacy SSB burst, where n is a natural number.

48-77. (canceled)

78. The method of claim 45, wherein the separate SSB has a periodicity the same as periodicity of a legacy SSB.

79. The method of claim 45, wherein the separate SSB has a periodicity different from periodicity of a legacy SSB, configuration of the separated SSB is indicated by a parameter.

80. The method of claim claim 45, wherein physical downlink shared channel (PDSCH) transmitted does not overlap with symbols and physical radio resources (PRBs) of the separate SSB.

81. The method of claim 45, wherein the transmitted separate SSB is associated with legacy SSBs, wherein indexes of the transmitted separate SSB are the same as indexes of the legacy SSBs.

82-88. (canceled).
